(19) United States
(12) Patent Application Publication
(10) Pub. No.: US 2004/0104675 A1
(43) Pub. Date: Jun. 3, 2004

(54) Evaporable getter device for cathode-ray tubes

(75) Inventors: Daniele Martelli, Milano (IT); Marialuisa Mantovani, Lainate (IT); Giuseppe Urso, Seregno (IT)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: SAES Getters S.p.A.

(21) Appl. No.: 10/721,199

(22) Filed: Nov. 25, 2003

Related U.S. Application Data
(63) Continuation of application No. PCT/IT02/00405, filed on Jun. 20, 2002.

(30) Foreign Application Priority Data
Jun. 26, 2001 (IT) MI2001A 001341

(51) Int. Cl. H01J 17/24

(52) U.S. Cl. 313/553

(57) ABSTRACT

An evaporable getter device for cathode-ray tubes (CRTS) is described, formed by a metallic container (101; 201) containing a mixture of powders (104; 205) of the compound BaAl₄ and nickel, Ni, and by two different metallic nets (106, 107; 207, 208), superimposed and positioned in said container over the powders. The device allows obtaining a barium distribution in the CRT that is more even and wider than that obtainable with a conventional device.

The present invention relates to an evaporable getter device for cathode-ray tubes (CRTs), used in television sets and monitors.

As known in the art, the getter materials are used in any applications wherein the maintenance of vacuum is required for a long time; in particular, CRTs contain evaporable getter materials capable of fixing traces of harmful gases that would compromise their proper operation.

Traces of gases may be left in CRTs during the production stage, even though an evacuation step is performed before final sealing of the tube, or may come from degassing of the materials forming the tubes.

To remove these traces of gas, barium metal is used which is deposited in form of a thin film on the internal walls of the CRT; this deposition is accomplished by means of a so-called evaporable getter device, formed by an open metallic container wherein is filled a mixture of powders of a barium compound, usually BaAl₄, and nickel, Ni, capable of releasing barium by evaporation, after sealing of the CRT; this mixture is referred to in the following as BaAl₄/Ni.

In order to evaporate barium, the container is heated preferably by induction, through a coil placed outside the tube, thus causing an increase in temperature of the powders to about 800° C. At these temperatures a strongly exothermic reaction takes place between BaAl₄ and Ni, that causes a further rise of temperature to about 1200° C., at which temperature barium evaporates; the metal then condenses in the form of a film on the conical wall and the mask of the CRT; this barium film is the active element in the gettering of gases.

For an optimal working of the CRT it is required that the barium film has a thickness as even as possible. A deposit of uneven thickness may have small projections from which, through gas absorption, barium particles may be lost which have a high probability to end on the electron gun and/or on the mask: in the first case, these particles may cause electric arcs and short circuits, in the second one they obstruct the passage of electrons and hence the formation of the image, thus causing the onset of dark spots on the screen. Moreover, a barium film with zones of high thickness has worsened characteristics of saturation by gases, causing consequently a reduction in the absorbing capacity of the getter.

In order to cope with these problems, patent IT 1,295,896 in the name of the present applicant describes a baffle that allows to diffuse the barium vapors along the walls of the tube and to produce even deposits. Through the use of such a baffle it is improved the distribution of barium, that becomes wider, more reproducible and deposited on the walls of CRT tube without involving the mask and the phosphors-bearing surface. In this case too, however, the barium layer shows a rather uneven thickness, thus not solving in a fully satisfactory way some of the above mentioned drawbacks.

U.S. Pat. No. 4,128,782 describes a U-shaped device containing a mixture BaAl₄/Ni to which titanium hydride, TiH₂, is mixed. When the barium evaporation temperature is reached, TiH₂ decomposes and the hydrogen thus formed acts as a diffusing means for the barium atoms that, by repeatedly hitting hydrogen molecules, travel non-linear paths and spread over a wide surface, thus forming deposits with a more regular thickness compared to the devices not containing the hydride. In this case however the extra-component, TiH₂, subtracts part of the volume available for the BaAl₄/Ni mixture; therefore, on the same dispenser size, inside the CRT there is released a lower barium amount than what would be released without the third component. In addition, titanium hydride is a rather expensive and troublesome to handle material, as it is readily flammable and reacts violently with water. A productive process involving such a compound would thus entail problems bound to safety, difficult to manage.

The object of the present invention is to provide a device that overcomes the above mentioned drawbacks.

Said object is achieved by means of an evaporable getter device comprising a metallic container containing a mixture of powders of the BaAl₄ compound and nickel, as well as two metallic nets having different wire diameter and apertures, that are superimposed and inserted in said container over said powders.

The net facing the powders of said mixture may be in direct contact with said powders or not (the following description, with reference to the attached drawings, exemplifies devices where the nets are not in contact with the powders). Either the finer net or the one with larger wire diameter and apertures can be placed in the container facing the mixture BaAl₄/Ni, but the arrangement where the net with wires of larger diameter faces the mixture is preferred, because avoids the risk that the wires of lower diameter melt during barium evaporation; this arrangement will be referred to for reference in the remainder of the description.

The fundamental advantage of the getter device according to the invention is to obtain during evaporation an even barium distribution leading, in the conical part and on the mask of the CRT, to a metal film of almost constant thickness.

This and other advantages and features of the device will be evident to those skilled in the art, from the following detailed description with reference to the attached drawings, wherein:

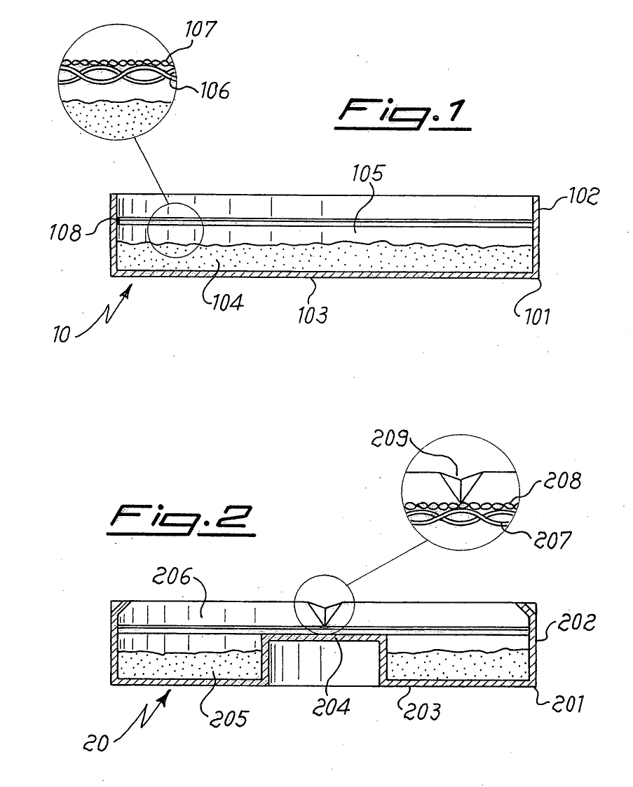

FIG. 1 shows a section of a first embodiment of the invention;

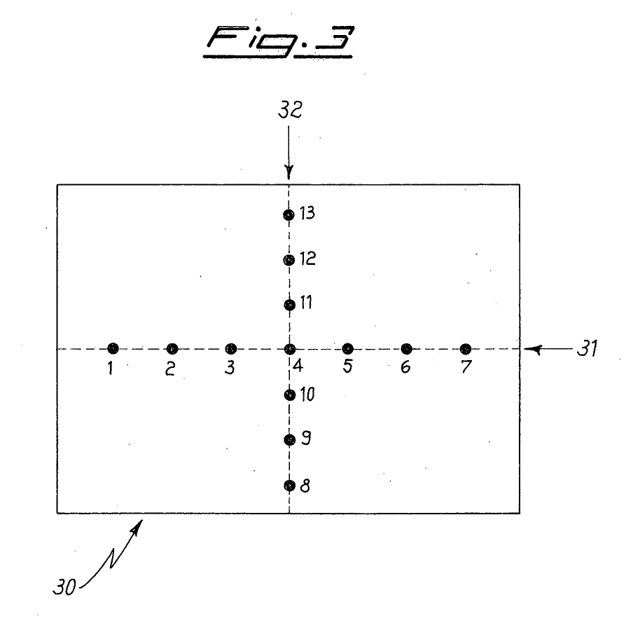

FIG. 2 shows a section of a second embodiment of the invention;

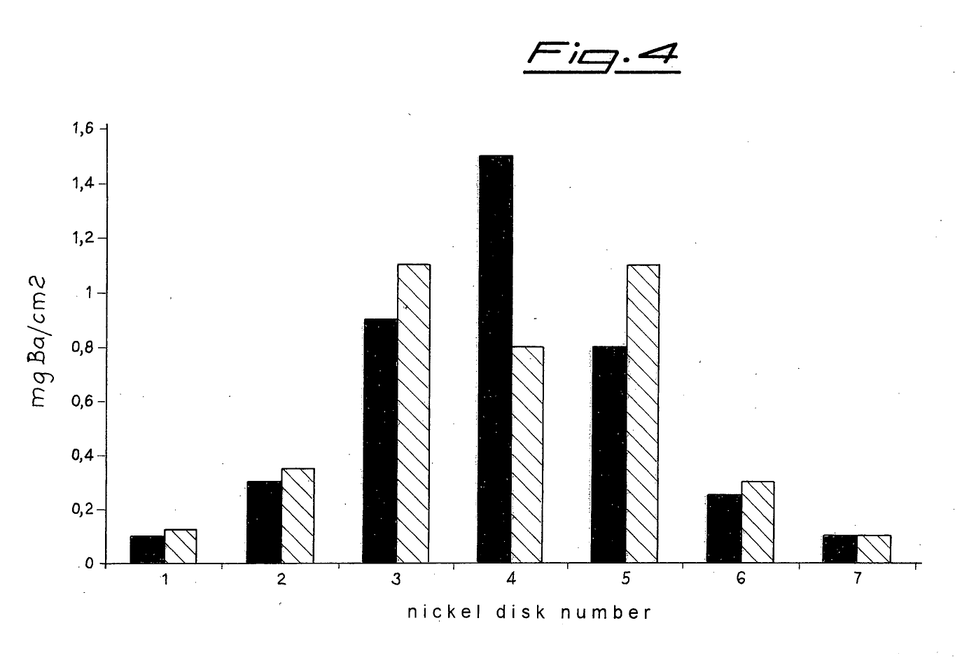

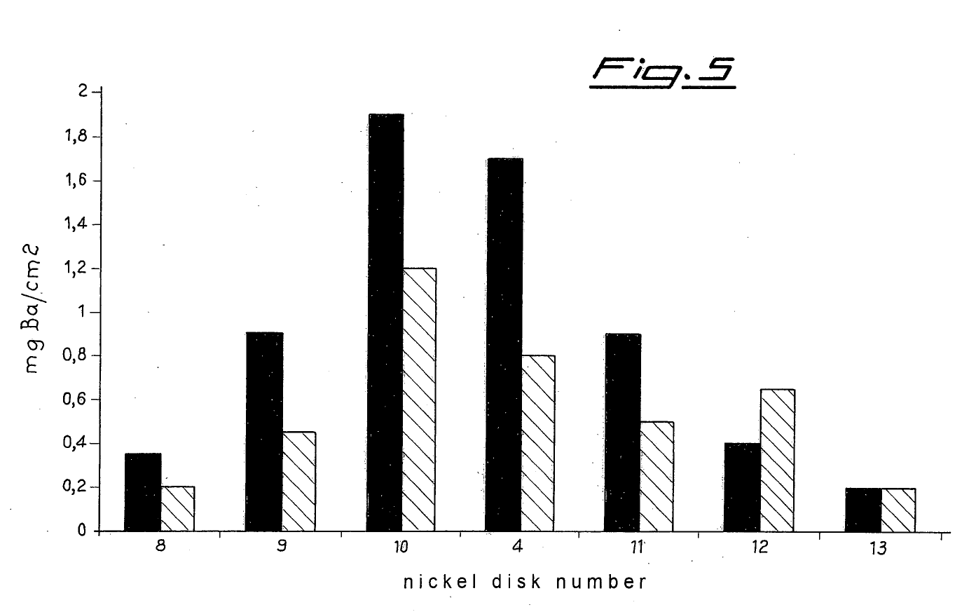

FIG. 3 shows schematically a mask of a CRT used in the experimental control of the invention;

FIGS. 4 and 5 reproduce in diagrammatic form the barium distribution results of evaporation tests carried out with inventive devices and prior art devices.

In the view of FIG. 1 there is illustrated the section of a device 10 according to a first embodiment of the invention; container 101 has a cylindrical shape and is made from a circular metal sheet, drop-forged so as to obtain an outer wall 102 and a bottom wall 103, defining a space 105 where powders 104 of the mixture BaAl₄/Ni are placed. Over said powders there is placed a first metal wire net 106, and over it a second metal wire net 107. In this first embodying example, the nets are secured to the outer wall 102 of container 101 by welding, as indicated in the drawing as element 108, for instance spot welding.

In FIG. 2 there is illustrated a device 20 according to a second embodiment of the invention. In this case container 201 has an annular form and is made out of a circular metal sheet, drop-forged so as to obtain an outer wall 202, a bottom wall 203 and a central coaxial rise 204. Walls 202 and 203 and rise 204 define an annular space 206 in which the powders 205 of mixture BaAl₄/Ni are placed. Over the powders of mixture BaAl₄/Ni and in contact with central rise 204, there is arranged a first metal wire net 207 and thereon a second metal wire net 208. In this embodiment, the nets are held in position through mechanical deformations 209 that are produced on outer wall 202 by means of a punch. Such deformations appear as pointed recesses with an almost triangular section, that from the outer perimeter of wall 202 extend inwardly in the container 201, thus holding the nets in a steady position. Obviously nets 207 and 208 can also be secured to container 201 by welding; similarly, in the case of container 101, the nets 106 and 107 can be held in position through mechanical deformations of outer wall 102.

The container (101, 201) and the nets (106, 107, 207, 208) are preferably made of steel. Preferred are the steels classified by the American Iron and Steel Institute (AISI) in the series AISI 300 and AISI 400, and particularly steel AISI 304.

The larger net is selected so as to have wire diameter comprised between 0.3 and 1.5 mm and apertures comprised between 1.4 and 2.4 mm; the finer net 107 is selected with wire diameter comprised between 0.025 and 0.050 mm and apertures comprised between 0.025 and 0.075 mm.

The advantages of the present invention will be evident from the following example.

### EXAMPLE

A device according to the invention is placed inside a 20 inches CRT in an “antenna” arrangement, that is, mounted on a thin rod connected to the tube wall.

FIG. 3 schematically represents the mask 30 of said CRT, on which are positioned two sets of nickel disks having a diameter of 1 cm: a first set is disposed along main axis 31 and the second along minor axis 32, so that the disk positioned in the center of the mask is the fourth of both sets. The disks are placed at a distance of 5.1 cm from each other along main axis 31 and at a distance of 3.8 cm along minor axis 32.

The CRT is then evacuated and sealed, and the getter device is inductively heated through a coil placed outside the tube at a position corresponding to the point where the device is arranged. After barium evaporation, the nickel disks are drawn, recording the original position in the CRT of each of these. Each disk is then brought in a beaker containing 100 cc of a 0.1 N aqueous solution of hydrochloric acid, HCl, thus dissolving the barium deposited on it; the barium concentration of the thus obtained solutions is quantitatively measured through atomic absorption spectroscopy, and by the measured concentration is then possible to obtain the amount of barium originally present on each disk.

The same procedure is then repeated by replacing the inventive device with a prior art device.

In FIGS. 4 and 5 there are shown the diagrams reporting the amount of barium on each nickel disk, in milligrams per square centimeter (mg Ba/cm²), as a function of the disk position on the mask of CRT (the numbers on the abscissa correspond to the numbering of disks in FIG. 3); in particular, FIG. 4 shows the barium distribution on the disks arranged along main axis 31, and FIG. 5 shows the barium distribution on the disks arranged along minor axis 32 of the mask. The amounts of barium are given in histograms, by hatched bars in the case of the devices of the invention and by full bars in the case of the prior art devices.

As it is clearly visible from said diagrams, with the inventive devices it is obtained a more even distribution of barium metal with respect to the distribution that can be obtained with the conventional devices.

Thanks to the presence and coupling of the two metal nets, another advantageous effect is obtained, that is, a remarkable abatement of particle loss from the BaAl₄/Ni mixture, both during the productive stage and operation of the CRTs; this allows avoiding the above mentioned drawbacks due to the presence of free particles.

1. An evaporable getter device (10; 20) comprising a metallic container (101; 201) containing a mixture of powders (104; 205) of the BaAl₄ compound and nickel, Ni, as well as two metallic nets (106, 107; 207, 208) having different wire diameter and apertures, that are superimposed and inserted in said container over said powders.

2. A device according to claim 1, wherein the first net (106, 207) has wire diameter comprised between 0.3 and 1.5 mm and apertures comprised between 1.4 and 2.4 mm, and the second net (107, 208) has wire diameter comprised between 0.025 and 0.050 mm and apertures comprised between 0.025 and 0.075 mm.

3. A device according to claim 2, wherein said first net faces the powders of the BaAl₄/Ni mixture.

4. A device (10) according to claim 1, wherein the container (101) of the powders has a cylindrical shape, with an outer wall (102) and a bottom wall (103) defining a space (105) containing said powders (104).

5. A device (20) according to claim 1, wherein the container (201) of the powders has an annular shape, with an outer wall (202), a bottom wall (203), and a central rise (204) defining an annular space (206) containing said powders (205).

6. The device according to claim 1, wherein the metallic nets (106, 107; 207, 208) are secured by welding to the outer wall (102; 202) of the container.

7. The device according to claim 1, wherein the metallic nets (106, 107; 207, 208) are held in position inside the container thanks to recesses of outer wall (102; 202) obtained through a mechanical deformation thereof.

8. The device according to claim 1, wherein the container (101; 201) and the metallic nets (106, 107; 207, 208) are formed of a steel selected in the AISI 300 and AISI 400 series.

9. The device according to claim 8, wherein said steel is AISI 304 steel.
